(19) United States
(12) Patent Application Publication
(10) Pub. No.: US 2026/0323743 A1
(43) Pub. Date: Oct. 15, 2026

(54) LOAD HANDLING DEVICE

(71) Applicant: Ocado Innovation Limited, Hatfield (GB)

(72) Inventors: Di KONG, London (GB); Geoff PATTERSON, London (GB)

(21) Appl. No.: 19/461,786

(22) Filed: Jan. 28, 2026

Related U.S. Application Data
(63) Continuation of application No. PCT/EP2024/072086, filed on Aug. 2, 2024.

(30) Foreign Application Priority Data
Aug. 4, 2023 (GB) 2311965.4
Aug. 4, 2023 (GB) 2311974.6

(51) Int. Cl. H04W 76/15; B65G 1/137; H04L 67/12; H04W 28/18; H04W 48/20; H04W 72/542

(52) U.S. Cl. CPC H04W 76/15; B65G 1/1371; H04W 28/18; H04W 48/20; H04W 72/542; H04L 67/12

(57) ABSTRACT

A load handling device designed to operate on the top of a cubic automated storage and retrieval system (ASRS). The load handling device comprises two wireless network interfaces, with one or more antennae being connected to each of the wireless network interfaces. The load handling device can establish two concurrent wireless communication links to different wireless access points. One of the links is used as a primary link, which is used in the control of the load handling device, and the other link is used as a secondary link

[symbol]

### RELATED APPLICATIONS

This application is a continuation application of International Patent Application No. PCT/EP2024/072086 entitled “Load Handling Device” filed 2 Aug. 2024, which claims priority from UK Patent Application No. GB2311974.6 entitled “Automated Storage & Retrieval System” filed 4 Aug. 2023 and from UK Patent Application No. GB2311965.4 filed 4 Aug. 2023 and entitled “Load Handling Device”; the content of all of which applications is incorporated herein by reference.

### FIELD OF THE DISCLOSURE

The disclosure relates to a load handling device, and in particular to a robotic load handling device which can be operated on a grid within a warehouse facility whilst connected to a wireless local area network.

### BACKGROUND

Grid-based automatic storage and retrieval systems are well known in the art. In such systems a plurality of robotic load handlers operate on a horizontal grid structure, underneath which is received a plurality of containers, arranged in a plurality of stacks. The containers are used to hold products and the load handlers are adapted to retrieve containers from one of the plurality of stacks and to deposit a container within one of the stacks. The load handlers may be routed in an autonomous manner (or a semi-autonomous manner) on the grid but a wireless communications system is required to transmit instructions to load handlers and to enable each of the load handlers to communicate with a management system. The claimed apparatus, methods, systems and computer programs are intended to provide improvements relating to communications systems for use in an automated retrieval and storage system which uses a fleet of robotic load handlers.

### SUMMARY

According to a first aspect of the present disclosure, there is provided a load handling device for use in a storage system, the load handling device comprising a first network interface and a second network interface, the load handling device being configured, in use, to establish a first communications link to the storage system using the first network interface and a second communications link to the storage system using the second network interface. One of the communications links may be a primary communications link, wherein data sent and received via the first communications link is used to control the operations of the load handling device. The other communications link may be is a secondary communications link, wherein data sent and received via the secondary communications link is a copy of the data sent and received via the primary communications link.

The use of two concurrent network connections enables one connection to be used to transmit data between the load handling deice and the storage system, whilst the other connection can remain ready for use. The other connection can be switched between wireless access points within the storage system to enable the load handling device to move thorough the storage system without losing a connection and reducing the risk of data being lost.

The first communications link may be between the first network interface and a first access point of a first access point group and the second communications link may be between the second network interface and a second access point of a first access point group. In particular, the first communications link may be between the first network interface and a first access point of a first access point group and the second communications link may be between the second network interface and a first access point of a second access point group.

The first communications link or the second communications link may be made the primary communications link in accordance with one or more measured parameters. The primary communications link may be transferred between the first communications link and the second communications link in accordance with one or more measured parameters.

The decision to make the first communications link or the second communications link the primary communications link may be made in accordance with the location of the load handling device in the storage system. The load handling device may comprise a look-up table which comprises data relating to network conditions in each storage system location, the network condition data being used in the decision to make the first communications link or the second communications link the primary communications link. The primary communications link may be transferred between the first communications link and the second communications link in accordance with the location of the of the load handling device in the storage system. The primary communications link may be transferred between the first communications link and the second communications link in accordance with the direction of movement of the of the load handling device in the storage system.

The decision to make the first communications link or the second communications link the primary communications link may be made in accordance with the data received by the load handling system from the storage system. More specifically, the primary communications link may be transferred between the first communications link and the second communications link in accordance with further data received by the load handling system from the storage system. The load handling device may be configured to change the first communications link and/or the second communications link in response to receiving a control message from the storage system. The load handling device may be configured to change the first communications link and/or the second communications link to a different wireless access point within the existing access point group. Alternatively, the load handling device may be configured to change the first communications link and/or the second communications link to a wireless access point in a different access point group. If the primary communications link is lost, then the secondary communications link may be designated as the primary link but the existing connection to the wireless access point is maintained.

According to a second aspect of the present disclosure, there is provided a storage system comprising: a first set of parallel tracks extending in an X-direction, and a second set of parallel tracks extending in a Y-direction transverse to the first set in a substantially horizontal plane to form a grid pattern comprising a plurality of grid spaces; a plurality of stacks of storage containers located beneath the tracks, and arranged such that each stack is located within a footprint of a single grid space; at least one load handling device as described above, the at least one load handling device being arranged to selectively move in the X and/or Y directions, above the stacks on the tracks and arranged to transport a storage container.

According to a third aspect of the present disclosure, there is provided a communications network for use in a storage system, the communications network comprising one or more wireless access point groups, the or each wireless access point group comprising a plurality of wireless access points.

The communications network may be configured, in use, to establish a first communications link to a load handling device via a first wireless access point and to establish a second communications link to the load handling device via a second access point. The first communications link may be established via a wireless access point in a first wireless access point group. The second communications link may be established via a wireless access point in a second wireless access point group. The first communications link may be used to transmit control and safety signals to the load handling device. The second communications link may be a back-up link in the event that the first communications link is lost.

According to a further aspect of the present disclosure there is provided a method of establishing communications links between a storage system and one or more load handling devices operating in the storage system, wherein the storage system comprises a plurality of wireless access points, the method comprising: a) determining, for each location in the storage system one or more parameter values for each of the plurality of wireless access points primary in that location; b) determining, for each location in the storage system a preferred wireless access point for a load handling bot to use for a primary connection at that location in accordance with the one or more parameter values determined in step a). The method may further comprise c) determining, for each location in the storage system one or more wireless access points for a load handling device to use for a secondary connection at that location in accordance with the one or more parameter values determined in step a).

In step a) the one or more parameter values may be measured, the measurements being made by one or more load handling devices. Alternatively, the one or more parameter values may be calculated based on a theoretical model. One or more of a plurality of load handling devices operating in the storage system may periodically report measured parameter values, the reported measured parameter values being used to update the parameter values determined in step a).

The one or more parameter values may be used to generate a look up table which holds the one or more parameter values for each location in the storage system. The look up table may be transmitted to one or more of the plurality of load handling devices operating in the storage system. Alternatively, portions of the look up table are periodically transmitted to one or more of the plurality of load handling devices operating in the storage system. The look up table may comprise the identity of one or more wireless access points suitable for supporting a primary connection for each location in the storage system. The look up table may further comprise the identity of one or more wireless access points suitable for supporting a secondary connection for each location in the storage system. Additionally, the look up table may comprise, for each location in the storage system, the identity of one or more wireless access points which are not suitable for supporting a primary or a secondary connection.

### BRIEF DESCRIPTION OF THE DRAWINGS

The load handling device will now be described in detail with reference to examples, in which:

FIG. 1 schematically illustrates a storage structure and containers;

FIG. 2 schematically illustrates track on top of the storage structure illustrated in FIG. 1;

FIG. 3 schematically illustrates load-handling devices on top of the storage structure illustrated in FIG. 1;

FIG. 4 schematically illustrates a single load-handling device with container-lifting unit in a lowered configuration;

FIG. 5 schematically illustrates cutaway views of a single load-handling device with container-lifting unit in a raised and a lowered configuration;

FIG. 6 shows a schematic depiction of a communication system according to the present disclosure;

FIG. 7 shows a schematic depiction of a bot for use with the communication system of the present disclosure;

FIG. 8 shows a schematic depiction of a grid which is covered by a first coverage area and a second coverage area;

FIG. 9 shows a schematic depiction of a further arrangement in which a grid is covered using four WiFi coverage areas; and

FIG. 10 shows a schematic depiction of a computer device which may be used in the performance of a method according to the present disclosure.

### DETAILED DESCRIPTION

The following embodiments represent the applicant's preferred examples of how to implement a communications system for use with robots in a warehouse but they are not necessarily the only examples of how that could be achieved.

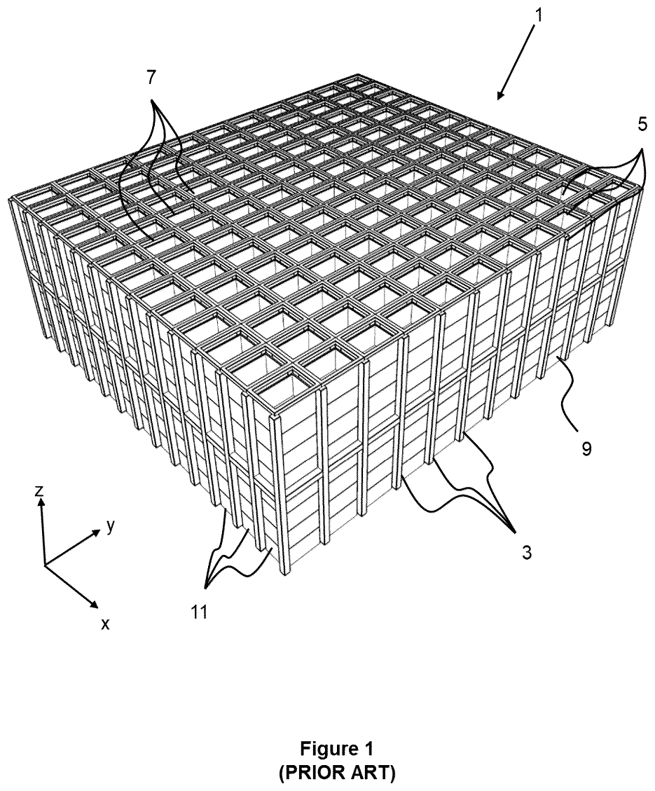

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

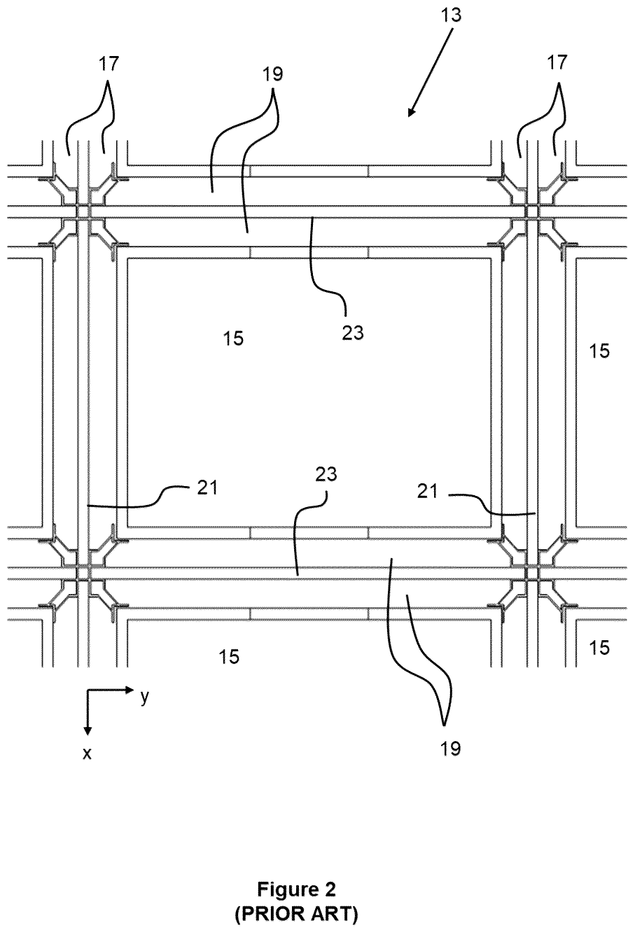

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

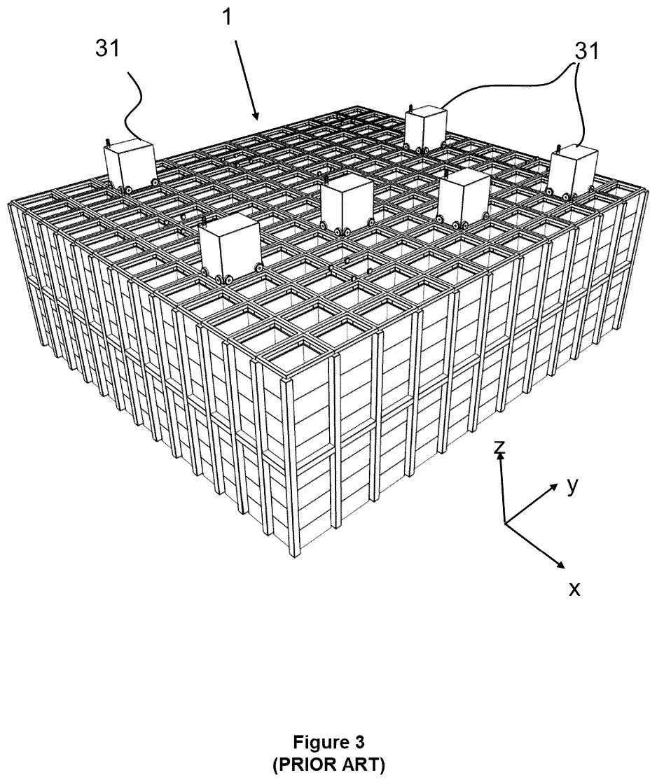

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

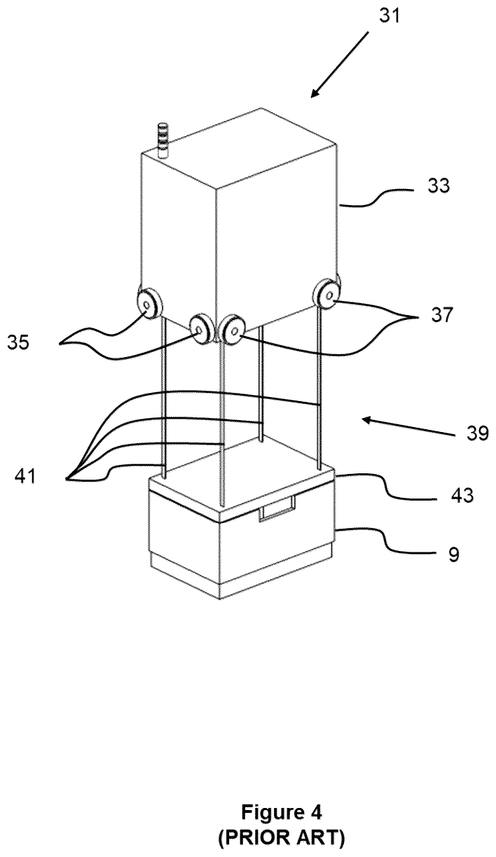

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting unit 39 configured to raise and lower containers 9. The illustrated container-lifting unit 39 comprises four tapes or reels 41 which are connected at their lower ends to a container-engaging assembly 43. The container-engaging assembly 43 comprises engaging mechanism (which may, for example, be provided at the corners of the assembly 43, in the vicinity of the tapes 41) configured to engage with features of the containers 9. For instance, the containers 9 may be provided with one or more apertures in their upper sides with which the engaging mechanism can engage. Alternatively or additionally, the engaging mechanism may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

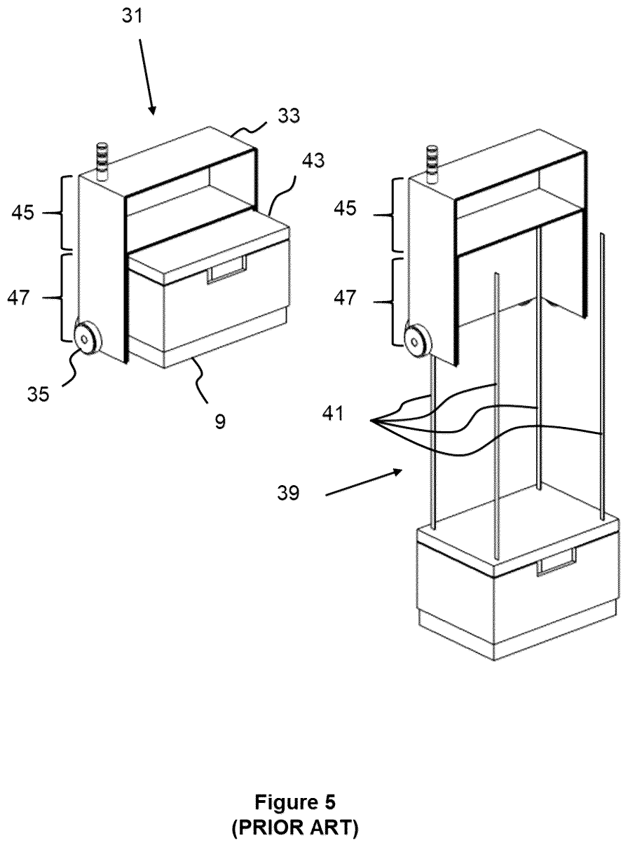

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting unit 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting unit 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, the upper and lower portions 45, 47 may not be physically divided by a specific component or part of the body 33 of the bot 31. As will be understood by a person skilled in the art, the bot shown in FIGS. 3 to 5 is a cavity bot, in which the container is received in a cavity inside the bot, but the present disclosure is equally relevant to cantilever bots or other bots or autonomous vehicles in storage systems which communicate via a wireless LAN.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

To remove a container 9 from the top of a stack 11, the bot 31 is moved as necessary in the X and Y directions so that the container-gripping assembly 43 is positioned above the stack 11. The container-gripping assembly 43 is then lowered vertically in the Z direction to engage with the container 9 on the top of the stack 11. The container-gripping assembly 43 grips the container 9, and is then pulled upwards on the tapes 41, with the container 9 attached. At the top of its vertical travel, the container 9 is accommodated within the vehicle body and is held above the level of the tracks. In this way, the load handling device 30 can be moved to a different position in the X-Y plane, carrying the container 9 along with it, to transport the container 9 to another location. The tapes 41 are long enough to allow the load handling device 30 to retrieve and place containers from any level of a stack 11, including the floor level. The weight of the vehicle may be comprised in part of batteries that are used to power the drive mechanism for the wheels 35, 37.

As shown in FIG. 3, a plurality of load handling devices 31 are provided, so that each bot 31 can operate simultaneously to increase the throughput of the system. The system illustrated in FIG. 3 may include specific locations, known as ports, at which containers 9 can be transferred into or out of the system. An additional conveyor system (not shown) is associated with each port, so that containers 9 transported to a port by a bot 31 can be transferred to another location by the conveyor system, for example to a picking station (not shown). Similarly, containers 9 can be moved by the conveyor system to a port from an external location, for example to a container-filling station (not shown), and transported to a stack 11 by the bots 31 to replenish the stock in the system.

Each bot 31 can lift and move one container 9 at a time. If it is necessary to retrieve a container (“target container”) that is not located on the top of a stack 11, then the overlying containers (“non-target containers”) must first be moved to allow access to the target container. This is achieved in an operation referred to hereafter as “digging”. During a digging operation, one of the bots 31 sequentially lifts each non-target container 9a from the stack 11 containing the target container 9b and places it in a vacant position within another stack 11. The target container 9b can then be accessed by the bot 31 and moved to a port for further transportation.

Each of the bots 31 is under the control of a grid controller. Each individual container 9 in the system is tracked, so that the appropriate containers 9 can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers 9, while allowing reasonably economical access to all of the containers 9 when required for picking.

It should be understood that it is necessary for messages to be transmitted to the bots. These may be short messages, for example an instruction to move a container from a first location to a second location, or the messages may be longer, for example an update to the computer code which is used to operate the bot or a component of the bot. Similarly, it may be necessary for the bot to send messages to a central management system, for example to report operating parameter values, operating state reports etc. An example of a communications system which can be used is disclosed in the Applicant's international patent application WO 2015/185726 and the corresponding U.S. Pat. Nos. 10,805,933 and 12,016,946, the entire contents of both of which are incorporated herein by reference.

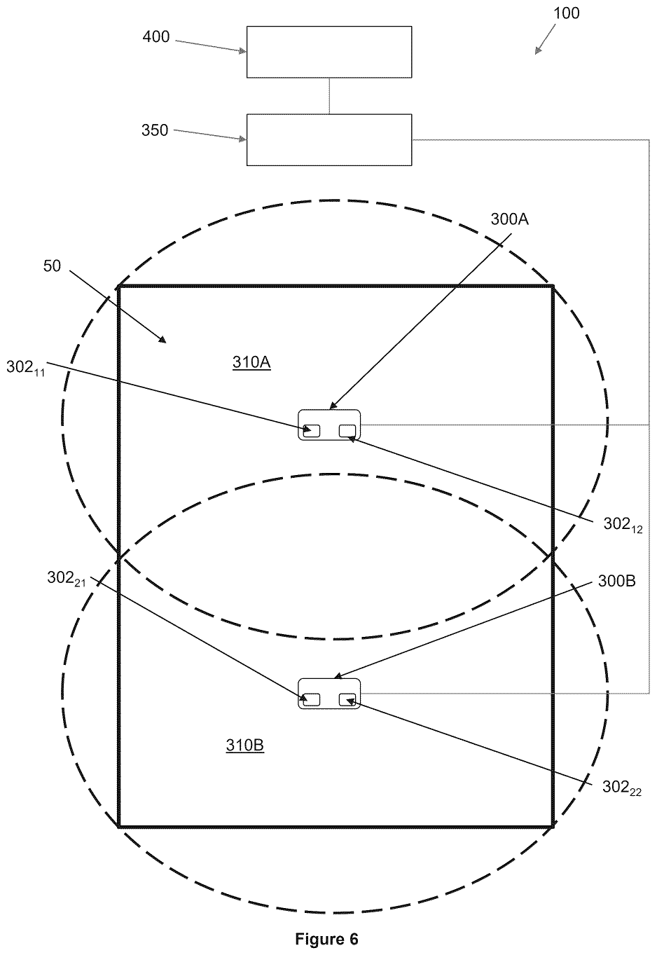

FIG. 6 shows a schematic depiction of a communication system 100 according to the present disclosure in which a fulfilment centre comprises a grid 50 upon which a plurality of bots 31 (not shown) move and operate, as described above with reference to FIGS. 1 to 5. The communication system 100 comprises two wireless access point groups 300A, 300B, each of which has an associated coverage area 310A, 310B (shown by the dashed lines). It should be understood that the shape of the coverage area is merely illustrative and not intended to be representative of the coverage area that will be achieved within a communication system according to the present disclosure.

It can be seen that the wireless access point groups 300A, 300B are located relative to the grid 50 such that the entirety of the grid is covered by at least one of the access point groups. Furthermore, it can be seen that the first coverage area 310A overlaps with the second coverage area 310B for a portion of the grid. A bot which is operating within the first coverage area 310A may communicate with the first wireless access point group 300A. A bot which is operating within the second coverage area 310B may communicate with the second wireless access point group 300B. A bot which is operating within the overlap region of the grid may communicate with either or both of the wireless access point groups 310A, 310B.

Each of the wireless access point groups 300A, 300B are connected to a gateway 350, which is in turn communicably connected to a central computing system 400. The central computing system controls and co-ordinates the operation of the bots and the other entities which are active in the storage system. Each of the access point groups comprises a plurality of access points. In the example shown in FIG. 6, each of the first and second access point groups comprises two access points. In particular, the first access point group 300A comprises first access point 302₁₁ and second access point 302₁₂, and the second access point group comprises third access point 302₂₁ and fourth access point 302₂₂. It should be understood that each access point group may comprise a greater number of access points. Although FIG. 6 shows that each of the access points in an access point group are co-located it should be understood that this need not be the case and that they may be located separately.

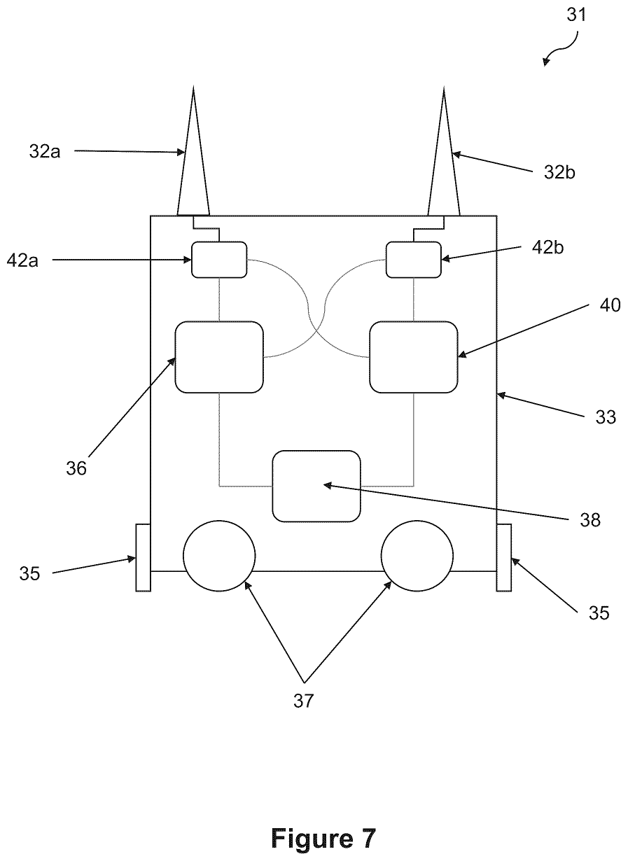

Notwithstanding the discussion above with respect to FIGS. 4 & 5, FIG. 7 shows a schematic depiction of a bot 31 for use with the communication system of the present disclosure. The bot 31 further comprises first wireless antenna 32a, second wireless antenna 32b, first wireless network card 42a, second wireless network card 42b, safety receiver 36, real time controller 38 and bot PC 40. The first and second wireless antennae 32a 32b are located on the exterior of the bot body 33 and are configured to receive signals transmitted by an access point. The first wireless antenna 32a is connected to the first wireless network card 42a such that data received via the first wireless network card 42a is routed to the safety receiver 36 and the bot PC 40. Similarly, the second wireless antenna 32b is connected to the second wireless network card 42b such that data received via the second wireless network card 42b is routed to the safety receiver 36 and the bot PC 40. In an alternative configuration, each of the first and second wireless network cards 42a 42b may be connected to a respective antenna group. In one example, each of the first and second wireless network cards 42a 42b may be connected to a respective antenna group comprising two antennae, such that each antenna in an antenna group can be used to form a spatial stream.

The signals received by the bot will comprise both control signals and safety signals. In one example, the control signals may be generated and transmitted separately from the safety signals. In an alternative example, the control signals and the safety signals may be transmitted together as a composite signal. In such a case, additional components may be provided (not shown in FIG. 7) to separate the control signals and the safety signals.

The received control signals are processed by the bot PC 40. The bot PC 40 is in communication with the first and second sets of wheels 35, 37 and can send signals to activate the first or second sets of wheels as appropriate. The bot PC 40 is also in communication with the container-lifting unit 39 (see FIGS. 4 & 5) and can control the container-lifting unit to, for example, lift a container from a stack within the grid structure into the bot, lower a container from within the bot into a stack within the grid, etc. Thus, the bot PC is able to interpret and execute the control signals such that the bot can be operated in an efficient manner as a part of the plurality of bots operating on the surface of the grid.

The received safety signals are processed by the safety receiver 36. If a safety condition is detected by the safety receiver then the safety receiver may cause the real time controller 38 to send a safety control signal to the bot PC 40. The reception of the safety control signal from the real time controller overrides the control signals received by the bot PC from the grid controller such that the operations of the bot are stopped. If the bot is in the process of moving from a first grid location to a second grid location then the bot will be stopped at its current location. A stationary bot which is in the process of lifting or lowering a container may complete that action but will not take any further action until the safety control signal is overridden.

In operation, a bot may establish a first connection with one of the access points of one of the access point groups using one of the wireless network cards, via the one or more antennae associated with that network card. The bot may also establish a second connection with a further access point of the access point group using the other wireless network card (and the one or more antennae associated with that wireless network card). One of the connections, for example the first connection, may be considered to be a primary connection such that it is used to receive control signals and safety signals from the central computing system (and to transmit data back to the central computing system). In such an example, the second connection may be designated as a back-up connection such that it is used to receive a second copy of the control signals and safety signals from the central computing system.

In the event that the first connection is lost or disrupted then the control signals and safety signals received via the second connection can be processed by the bot PC and the safety receiver to operate the bot, and any data which needs to be sent to the central computing system may be transmitted using the second connection. Thus, it can be seen that the use of the two parallel connections reduces the risk that the link between a bot and the central computing system is lost. In an alternative arrangement, the secondary connection may be a channel which is only used when the primary connection is lost, such that the control signals and safety signals can be transmitted over the secondary connection.

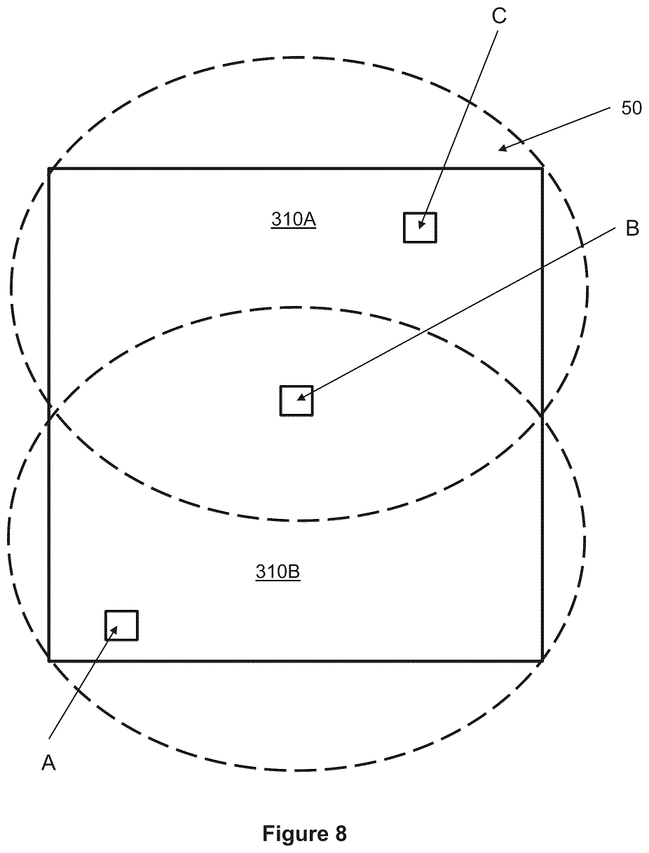

FIG. 8 shows a schematic depiction of a grid 50, which is a simplified view of the grid described above with respect to FIG. 6. The grid is covered by the first coverage area 310A and the second coverage area 310B, which are respectively associated with the first access point group 300A and the second access point group 300B (neither of which are shown in FIG. 8 for the sake of clarity). Consider the scenario in which a bot is instructed to move from location A to location B in order to retrieve a container that is stored at location B. The bot then has to move to location C such that the container can be deposited at location C. At location A, the bot is within the second coverage area 310B and thus can only connect to the second access point group 300B. For example, the bot may make a first connection between the first wireless network card 42a of the bot and the third wireless access point 302₂₁. The bot may also make a second connection between the second wireless network card 42b and the fourth wireless access point 302₂₂.

As the bot moves from location A towards location B, it will move from a position from which it is only able to connect to an access point in the second access point group to a position from which it is able to connect to an access point from either the first access point group or the second access point group (i.e. it has moved into the overlap region). Once it reaches such a point, the bot may release one of the first connection or the second connection and seek to make a further connection to one of the access points of the first access point group. For example, the bot may decide to release the connection which has the lowest performance metric value. This may be, for example, the connection which has the lowest RSSI (Received Signal Strength Indicator) value. It should be understood that other parameters or measures of signal strength and/or quality may be used. The wireless network card associated with the released connection will then connect to either the first wireless access point 302₁₁ or the second wireless access point 302₁₂. The connection to either the first wireless access point or the second wireless access point may be made in accordance with the value of a performance metric. For example, the connection may be made to the wireless access point which can provide the highest RSSI value for the associated connection. For example, the bot may retain the first connection between the first wireless network card 42a and the third wireless access point 302₂₁ and may establish a second connection between the second wireless network card 42b and the second wireless access point 302₁₂.

After the container has been retrieved at location B, the bot will move on to location C. Once the bot moves out of the overlap region, then it is no longer able to connect to an access point in the second access point group 300B. As a consequence of this movement, the first connection between the first wireless network card 42a and the third wireless access point 302₂₁ can no longer be sustained and is dropped. The bot will then form a further connection, in this case between the first wireless network card 42a and the first wireless access point 302₁₁.

It can be seen from the above example that the bot maintains two connections as it moves across the grid. At location A, the bot has a first connection to the third wireless access point 302₂₁ and a second connection to the fourth wireless access point 302₂₂. The bot will assign one of these connections as being the primary connection, with the other connection being assigned as the secondary connection. As the bot moves into the overlap region when it approaches location B, the secondary connection to the wireless access point in the second access point group 300B is dropped and is remade to a wireless access point in the first access point group 300A.

As the bot moves towards location C, the strength of the secondary connection will increase relative to that of the primary connection as the bot moves further from the second access point group 300B and closer to the first access point group 300A. When the ratio of the signal strengths reaches a predetermined level, then the secondary connection will become the primary connection and the previously primary connection will become the secondary connection. For example, this may occur when the signal strength of the secondary connection becomes equal to that of the primary connection, but it should be understood that different threshold values or conditions may be used.

As the bot moves further towards location C it will leave the overlap region and thus the secondary connection to the wireless access point in the second access point group 300B is dropped and is remade to a wireless access point in the first access point group 300A, such that both the primary and secondary connections are between the bot and the first access point group 300A. During the movement of the bot, the primary connection is used to send and receive data that is used to control the movement and operations of the bot, with the secondary connection being maintained in the event that the primary connection is lost. It should be understood that when a bot is moving in a region such that both connections are to the same first access point group then the bot may re-configure itself such that the first connection goes from being the primary connection to becoming the secondary connection and consequently, the second connection going from being the secondary connection to becoming the primary connection.

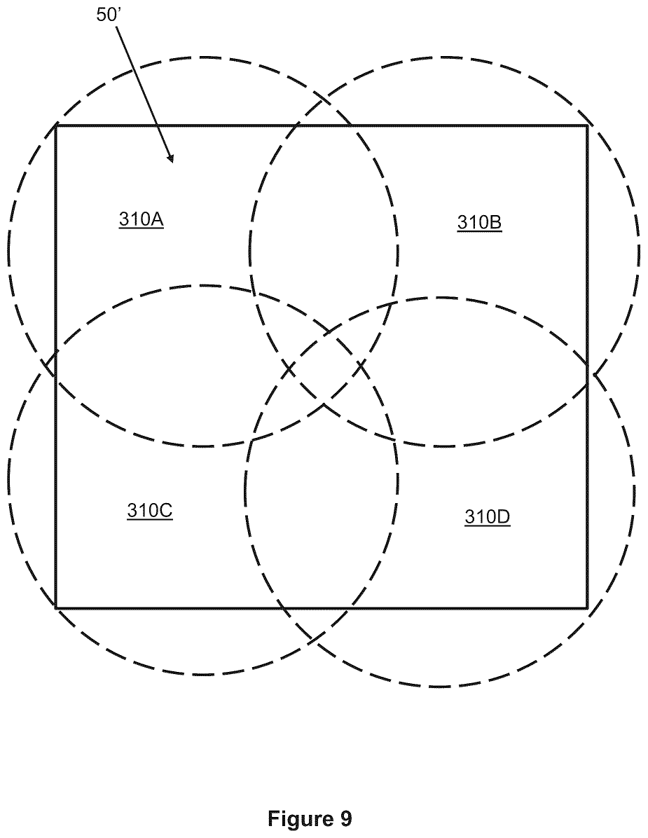

FIG. 9 shows a schematic depiction of a further arrangement in which a grid 50′ is covered using four WiFi coverage areas 310A, 310B, 310C, 310D. Such an arrangement may be needed because the grid 50′ of FIG. 9 covers a larger area than the grid 50 of FIG. 8, because a greater number of bots are to be operated on the grid 50′ of FIG. 9, or for some other reason. A bot moving from a first coverage area to a second coverage area, and moving into or through one or more overlap regions, will manage the first and second network connections using the same principles as described above with reference to FIG. 8. It should be understood that the number of WiFi access point groups (and thus the number of coverage areas) required to cover the grid of an automated storage and retrieval system will vary with the size and shape of the grid.

In one example of the present disclosure, the signal strength and/or quality in each grid cell may be calculated using theoretical models in accordance with the size and shape of the grid of the storage system, the number of access point groups installed and their location relative to the grid, the number of access points in each access point group (which may vary between access point groups), the position and size of structural elements within the grid (for example, columns which are supporting the roof), etc. On the basis of these calculations it is possible to generate a listing of access points which are accessible from each grid location such that they can be used by a load handling device for either a primary connection or a secondary connection.

In an alternative example of the present disclosure, once the storage system has been constructed, a small number of bots may be inducted onto the grid of the storage system and then controlled to move around the grid, such that the signal strength and/or quality is measured for each of the grid locations. The measured data is then reported back to the central computing system and collated. The collated data can then be used to generate the listing of access points which are accessible from each grid location such that they can be used by a load handling device for either a primary connection or a secondary connection.

In a further example, the listing of access points can be calculated based on theoretical models and a small number of bots is then used to measure the signal strength and/or quality at each of the grid locations and the measured data can be compared with the theoretical calculations. The listing of access points may be updated in accordance with the measured data. The measured data may also be used to modify and update the theoretical models used in the calculation of signal strength and/or quality.

The access point listing can be used to generate a mapping table which can be transmitted to each of the bots that can be used with the storage system. The mapping table may take the form of one or more preferred access points for the primary connection and one or more preferred access points for the secondary connection for each grid location within the storage system.

In an alternative form, each access point which is accessible from a grid location may be classified. In one example, each accessible access point may be classified as Red, Amber or Green. An access point which is classified as Red is one which is accessible from a grid location but the signal strength and/or quality is such that it would not provide a reliable connection. An access point which is classified as Amber is one where the signal strength and/or quality is such that it is suitable for use as a secondary connection but is not thought to be of sufficient quality to support a primary connection. An access point which is classified as Green is one where the signal strength and/or quality is of sufficient quality to support a primary connection. Thus, a bot may use a Green access point for the primary connection and an Amber access point for the secondary connection. In the case that there is sufficient network capacity then a bot may be able to use a Green access point for the secondary connection.

In the event that the creation of the mapping table indicates that regions of the grid have relatively poor coverage, for example a low ratio of Green access points relative to the number of Amber access points then this information may be used in re-configuring the network. For example, one or more further access points may be added to an access point group, or beam forming may be used if the wireless access points comprise MIMO (multiple input multiple output) antennae. It should be understood that the mapping table may take a different form from those described above.

Once the mapping table has been generated, it can be transmitted by the central computing system to each of the bots active in the storage system. When a bot is inducted onto the grid, a check may be made that the mapping table is current and if not then an update can be pushed out by the central computing system. It will be understood that when the storage system is in operation, the presence of many bots on the grid (a large storage system may comprise several hundred active bots) may affect the signal strength due to reflections or other interference. Some or all of the active bots may periodically report back the measured signal strength to the central computing system and the reported data may be used to update the mapping table. The updated regions of the mapping table may then be sent to the active bots.

It can be seen from the above discussion with respect to FIG. 8 and the movement of a bot from position A to position C that the bot will need to make a connection to an access point in the first access point group. It can be seen that it is desirable to minimise the number of re-connections that are made during the movement of the bot from A to C. Once a route for the bot has been determined (for example, supplied to the bot from the central computing system or determined by the bot PC) then the route data can be compared with the mapping table. If possible, when the bot moves into the overlap region then the secondary connection is made to an access point which can support a secondary connection (that is, an access point classified as Green or Amber in the above example) in the overlap region and that can also support a primary connection near to and at location C (that is, an access point classified as Green in the above example). If this is not possible, then the access points may be selected so as to minimise the number of re-connections that are required whilst the bot moves along the pre-determined route. Furthermore, the data held by the mapping table may be used to initiate a handover from a first access point to a second access point such that the secondary connection can be maintained at a preferred quality level, for example initiating the handover to avoid the connection being made to a Red access point for a portion of the route.

There may be situations in which the operation of the storage systems causes a disproportionate number of bots to gather in a relatively small region of the grid. In such a case, too many bots may attempt to connect to the access points which are suitable for supporting a primary connection (that is, those access points classified as Green in the above example). The excessive number of connection attempts may degrade the network performance. In such a case, the central computing system may initiate a load-balancing procedure such that the primary connections are spread more evenly across the access points which are suitable for supporting a primary connection. Furthermore, one or more of the bots may have their primary connections re-made to an access point which under normal conditions would be suitable for use for secondary connections (that is, those access points classified as Amber in the above example). In some cases, it may also be necessary to re-make one or more of the secondary connections to access points having a lower quality (that is, those access points classified as Red in the above example) such that there is the capacity to reallocate one or more of the primary connections.

As an alternative, or in addition to this load-balancing procedure, the network may be reconfigured to provide additional capacity on a temporary basis, for example by re-configuring MIMO antennae to provide more bandwidth to the area where the bots are concentrated, activating inactive access points within an access point group, etc. After the bots have dispersed then the load-balancing and/or the network re-configuration may be undone.

It should be understood that frequent calls for load-balancing and/or the network re-configuration may be used as an indication that permanent changes to the network configuration may be required, for example, installing one or more new access point groups, re-locating one or more existing access point group, adding one or more new access points to an existing access point group, etc.

There are some situations in which a connection between the bot and one of the access points may be lost. For example, the access point supporting a connection may fail or there may be a failure in the bot, for example relating to one of the wireless antennae 32 or one of the wireless network interfaces 42. In the event that the fault is in the bot then it will be necessary to recover the bot for maintenance activity. The bot can be controlled remotely so as to move it back to a maintenance region using the one operative connection. As the bot moves into an overlap region the bot will need to terminate the operative connection and then make a new connection to an access point in the area that the bot is to move into. Such a process will need to be repeated as the bot navigates across the grid.

If the access point has failed, then the bot will attempt to make a further connection using the antenna and network interface which was previously connected to the access point. Referring to the example discussed above with respect to FIG. 8, if the bot is near to location A and the connection to the fourth wireless access point 302₂₂ is lost then the bot will attempt to connect to either the first wireless access point 302₁₁ or the second wireless access point 302₁₂, in order to establish a secondary connection. If such a secondary connection can be made then the bot will be able to continue to move to location C in order to complete its action. In the case where an access point fails, then the behaviour of the bots may be modified such that lower quality connections may be used for primary and/or secondary connections. Using the example given above, a potential connection which is classified as Amber may be used for a primary connection. Similarly, a potential connection which is classified as Red may be used for a secondary connection.

Given the failure of an access point, the access point group associated with the access point will have decreased network capacity. In such a situation, the central computing system can vary the routing algorithm used to determine the route of a bot from a first location to a second location such that fewer bots are routed through the area covered by the affected access point group. If possible, some of the loss of capacity may be mitigated, for example by activating additional access points, by activating beam forming in other access points, etc. When the access point is restored then the storage system can revert to normal operations.

Referring again to the above example, if the bot is not able to connect to either the first wireless access point 302₁₁ or the second wireless access point 302₂₁ then the bot is left with only a single operative connection. This is equivalent to the situation where there is a failure of a bot antenna or network interface. In such a case, the bot can be controlled remotely using the operative connection until the bot can be routed to a position where a secondary connection can be established to a further access point. Once the secondary connection is established then the bot can continue with normal operation.

The access points and the wireless network interfaces may be selected to conform to one of the wireless LAN standards, such as IEEE 8021.11n (sometimes referred to as WiFi 4), 802.11ac (WiFi 5) or 802.11ax (WiFi 6). As further technical standards are agreed upon, e.g., set or adopted by a standard setting organization, and compliant devices released then access points and the wireless network interfaces using such new standards may be adapted for use according to the present disclosure. The IEEE standard 8021.11be, a.k.a., WiFi 7 or Extremely High Throughput (EHT), is an example of a new standard that can be used within the scope of the present disclosure. It will be understood that standards-compliant devices will be selected to provide a desired level of network capacity and performance. It will be understood from the foregoing discussion that the native capabilities of the access points and the wireless network interfaces will be used to manage channels, etc., in the wireless LAN.

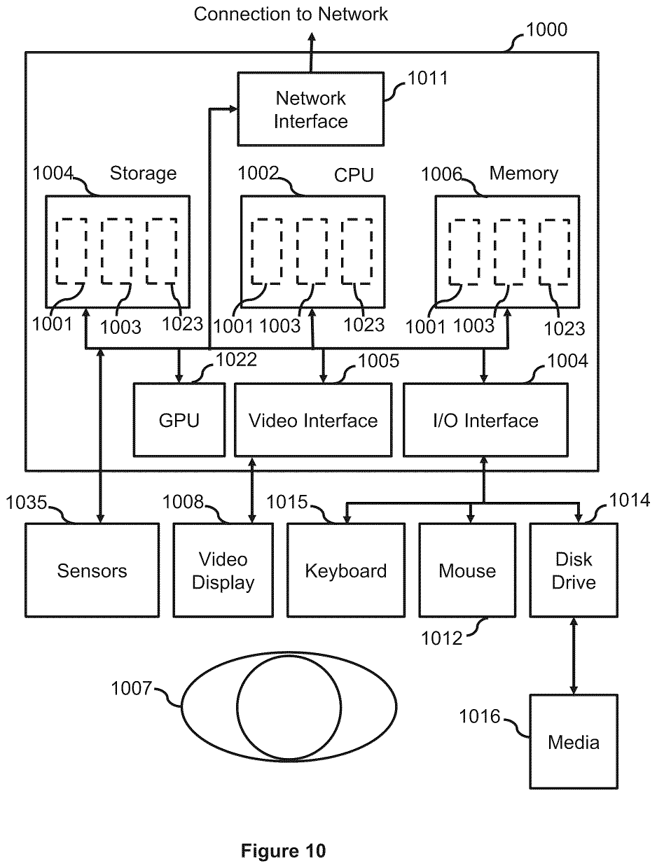

The present system and method may be practiced in various embodiments. A suitably configured computer device, and associated communications networks, devices, software and firmware may provide a platform for enabling one or more embodiments as described above. By way of example, FIG. 10 shows a schematic depiction of a computer device 1000 that may include a central processing unit (“CPU”) 1002 connected to a storage unit 1014 and to a random access memory 1006. The CPU 1002 may process (e.g., run or implement) an operating system 1001, application program 1003, and data 1023. The operating system 1001, application program 1003, and data 1023 may be stored in storage unit 1014 and loaded into memory 1006, as may be required. Computer device 1000 may further include a graphics processing unit (GPU) 1022 which is operatively connected to CPU 1002 and to memory 1006 to offload intensive image processing calculations from CPU 1002 and run these calculations in parallel with CPU 1002. An operator 1007 may interact with the computer device 1000 using a video display 1008 connected by a video interface 1005, and various input/output devices such as a keyboard 1015, mouse 1012, and disk drive or solid state drive 1014 connected by an I/O interface 1004. In known manner, the mouse 1012 may be configured to control movement of a cursor in the video display 1008, and to operate various graphical user interface (GUI) controls appearing in the video display 1008 with a mouse button. The disk drive or solid state drive 1014 may be configured to accept computer readable media 1016. The computer device 1000 may form part of a network via a network interface 1011, allowing the computer device 1000 to communicate with other suitably configured data processing systems (not shown). One or more different types of sensors 1035 may be used to receive input from various sources. It will be appreciated that while CPU 1002 is shown as a single element, in some embodiments and examples, CPU 1002 may include multiple linked CPUs, i.e., CPU 1002 may be composed of one or more linked, networked, or cooperating processing units/devices.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g., an optical disc, a magnetic disk, optical tape, magnetic tape, etc.), on one or more data storage portions/partitions of a computing device, such as memory associated with a computer and/or a storage system (storage means).

The mobile application of the present invention may be implemented as a web service, where the mobile device includes a link for accessing the web service, rather than a native application. The functionality described may be implemented to (in or with) any mobile platform, including the Android platform, iOS platform, Linux platform or Windows platform or the like. In further aspects, the disclosure provides systems, devices, methods, and computer programming products, including non-transient machine-readable instruction sets, for use in implementing such methods and enabling the functionality described previously.

In one or more aspects, the present disclosure provides a load handling device designed to operate on the top of a cubic automated storage and retrieval system. The load handling device can include two wireless antennae, each with a respective wireless network interface. The load handling device can establish two concurrent wireless communication links to different wireless access points. One of the links can be used as primary link, which can be used in the control of the load handling device, and the other link can be used as a secondary link.

What is claimed is:

1. A load handling device for use in a storage system, the load handling device comprising a first network interface and a second network interface, the load handling device being configured, in use, to establish a first communications link to the storage system using the first network interface and a second communications link to the storage system using the second network interface, wherein the first communications link is between the first network interface and a first access point of a first access point group and the second communications link is between the second network interface and
(i) a second access point of the first access point group; or
(ii) a first access point of a second access point group.

2. A load handling device according to claim 1, wherein one of the first or second communications links is a primary communications link, wherein data sent and received via the first communications link is used to control the operations of the load handling device.

3. A load handling device according to claim 2, wherein the other of the of the first or second communications links is a secondary communications link, wherein data sent and received via the secondary communications link is a copy of the data sent and received via the primary communications link.

4. A load handling device according to claim 1, wherein the first communications link or the second communications link is made the primary communications link in accordance with one or more measured parameters.

5. A load handling device according to claim 4, wherein the primary communications link is transferred between the first communications link and the second communications link in accordance with one or more measured parameters.

6. A load handling device according to claim 1, wherein the decision to make the first communications link or the second communications link the primary communications link is made in accordance with the location of the load handling device in the storage system.

7. A load handling device according to claim 6, wherein the load handling device comprises a look-up table which comprises data relating to network conditions in each storage system location, the network condition data being used in the decision to make the first communications link or the second communications link the primary communications link.

8. A load handling device according to claim 6, wherein the primary communications link is transferred between the first communications link and the second communications link in accordance with the location of the of the load handling device in the storage system.

9. A load handling device according to claim 6, wherein the primary communications link is transferred between the first communications link and the second communications link in accordance with the direction of movement of the of the load handling device in the storage system.

10. A load handling device according to claim 1, where the decision to make the first communications link or the second communications link the primary communications link is made in accordance with the data received by the load handling system from the storage system.

11. A load handling device according to claim 10, wherein the primary communications link is transferred between the first communications link and the second communications link in accordance with further data received by the load handling system from the storage system.

12. A load handling device according to claim 1, wherein the load handling device is configured to change the first communications link and/or the second communications link to the storage system in response to receiving a control message from the storage system.

13. A load handling device according to claim 12, wherein the load handling device is configured to change the first communications link and/or the second communications link to a different wireless access point within the existing access point group.

14. A load handling device according to claim 12, wherein the load handling device is configured to change the first communications link and/or the second communications link to a wireless access point in a different access point group.

15. A load handling device according to claim 2, wherein if the primary communications link is lost, then the secondary communications link is designated as the primary link but the existing connection to the wireless access point is maintained.

16. A load handling device according to claim 1, wherein the storage system comprises a first set of parallel tracks extending in an X-direction, a second set of parallel tracks extending in a Y-direction transverse to the first set in a substantially horizontal plane to form a grid pattern comprising a plurality of grid spaces and a plurality of stacks of storage containers located beneath the tracks, and arranged such that each stack is located within a footprint of a single grid space;
the load handling device further comprising:
a wheel assembly arranged to selectively move in the X-direction or the Y-direction; and
a container lifting device arranged, in use, to lift a container from one of the plurality of stacks into the interior of the load handling device.

17. A method of establishing communications links between a storage system and one or more load handling devices operating in the storage system, wherein the storage system comprises a plurality of wireless access points, the method comprising the steps of:
(a) determining, for each location in the storage system one or more parameter values for each of the plurality of wireless access points primary in that location;
(b) determining, for each location in the storage system a preferred wireless access point for a load handling device to use for a primary connection at that location in accordance with the one or more parameter values determined in step (a);
(c) determining, for each location in the storage system one or more wireless access points for a load handling device to use for a secondary connection at that location in accordance with the one or more parameter values determined in step (a);
Wherein the one or more parameter values are used to generate a look up table which holds the one or more parameter values for each location in the storage system, the look up table is transmitted to one or more of a plurality of load handling devices operating in the storage system such that each of the plurality of load handling devices operating in the storage system establish a primary connection to a wireless access point and a secondary connection to a wireless access point in accordance with the contents of the look up table.

18. A method according to claim 17, wherein one or more of a plurality of load handling devices operating in the storage system periodically report measured parameter values, the reported measured parameter values being used to update the parameter values determined in step (a), such that the updated parameter values are used to periodically update the look up table, the updated look up table being transmitted to one or more of a plurality of load handling devices operating in the storage system.

19. A method according to claim 17, wherein in step (a) the one or more parameter values are measured, the measurements being made by one or more load handling devices.

20. A method according to claim 17, wherein in step (a) the one or more parameter values are calculated based on a theoretical model.
